(19) United States
(12) Patent Application Publication
(10) Pub. No.: US 2018/0018797 A1
(43) Pub. Date: Jan. 18, 2018

(54) IMPACT VISUALIZATION SYSTEM, METHOD, AND PROGRAM

(71) Applicant: NEC Corporation, Tokyo (JP)

(72) Inventors: Yousuke MOTOHASHI, Tokyo (JP); Rychei FUJIMAKI, Tokyo (JP)

(21) Appl. No.: 15/550,251

(22) PCT Filed: Jan. 27, 2016
(86) PCT No.: PCT/JP2016/000406

§ 371 Date: Aug. 10, 2017

Related U.S. Application Data
(60) Provisional application No. 62/117,555, filed on Feb. 18, 2015.

(51) Int. Cl. G06T 11/20; G06F 7/02; G06N 7/00

(52) U.S. Cl. CPC G06T 11/206; G06N 7/005; G06F 7/023; G06F 7/026

(57) ABSTRACT

In an impact visualization system that enables visualization of impacts of explanatory variables used in a prediction formula, the prediction formula being expressed by a linear sum of functions of the explanatory variables, an explanatory variable display unit 81 displays the explanatory variables used in the prediction formula on one dimensional axis by allocating a predetermined width to a respective one of the explanatory variables. A function value display unit 82 sets values or segments of the explanatory variables in the widths allocated thereto, in accordance with possible values or segments of the respective explanatory variables, and plots values of the functions specified by the values or the segments that have been set, at corresponding positions in another dimensional axis direction.

### TECHNICAL FIELD

The present invention relates to an impact visualization system, an impact visualization method, and an impact visualization pro ram that enable visualization of the impacts of explanatory variables used in prediction formulas.

### BACKGROUND ART

Recently, there are increasing occasions where accumulated data are analyzed to make future predictions. Data accumulated may often include different regularities so there is a method of making predictions while switching between a plurality of prediction formulas according to the conditions.

For example, Non Patent Literature 1 (NPL 1) describes extracting complicated rules and patterns by using a heterogeneous mixture learning technology and outputting a model of the learned results. The learned results described in NPL 1 include prediction formulas classified according to the factors such as date of the week, temperature, etc., and each prediction formula is expressed by a linear sum of weighted explanatory variables indicating the respective factors.

NPL 1 also describes a method of displaying influential factors (contributing factors) used when making predictions by switching between the prediction formulas. The display method illustrated in FIG. 7 in NPL 1 is called a stem plot. According to the display method described in NPL 1, the influential factors (explanatory variables) are arranged along the stem, and the impacts (coefficients) of the influential factors (explanatory variables) in the respective prediction formulas are expressed cumulatively in the form of bars having the lengths corresponding to the impacts, as in the histogram.

### CITATION LIST

### Non Patent Literature

NPL 1: NEC Corporation, “Data Utilization by Advanced Machine Learning Technology”, Administration & Information Systems, The Institute of Administrative Information Systems, October 2014, Vol. 50, pp. 84-87

### SUMMARY OF INVENTION

### Technical Problem

FIG. 7 is a diagram illustrating an example in which a prediction formula is expressed by a stem plot. In the example shown in FIG. 7, a prediction formula y is expressed by a linear sum of explanatory variables xᵢ, and the coefficient of each explanatory variable is expressed by the corresponding length. As illustrated in FIG. 7, the method of expressing each coefficient of the explanatory variable by a stem plot is a very useful method as it allows the impact of each explanatory variable to be understood at a glance.

In the example shown in FIG. 7, it is assumed that a prediction formula is expressed by a linear sum of weighted explanatory variables. The weighting value is uniquely determined for an explanatory variable even in the case where the explanatory variable may take any value (segment). This makes it possible to express the impact of each explanatory variable with a simple stem plot, as illustrated in FIG. 7.

On the other hand, there may be a case where the impact of an explanatory variable on a predicted value (objective variable) varies in accordance with the value (segment) of the explanatory variable. Even with the same prediction formula, if the impacts vary according to the values of the explanatory variables, it will be difficult to express the impacts on the objective variable using such a simple stem plot as described in NPL 1.

In view of the foregoing, an object of the present invention is to provide an impact visualization system, an impact visualization method, and an impact visualization program that enable visualization of the impacts of explanatory variables on a prediction result such that a user can readily understand the impacts even in the case where the impacts of the explanatory variables on the prediction result vary according to the values or segments of the explanatory variables.

### Solution to Problem

An impact visualization system according to the present invention is an impact visualization system that enables visualization of impacts of explanatory variables used in a prediction formula, the system including: an explanatory variable display unit which, with the prediction formula being expressed by a linear sum of functions of the explanatory variables, displays the explanatory variables used in the prediction formula on one dimensional axis by allocating a predetermined width to a respective one of the explanatory variables; and a function value display unit which, in accordance with possible values or segments of the respective explanatory variables, sets values or segments of the explanatory variables in the widths allocated thereto, and plots values of the functions specified by the values or the segments that have been set, at corresponding positions in another dimensional axis direction.

An impact visualization method according to the present invention is an impact visualization method that enables visualization of impacts of explanatory variables used in a prediction formula, the method including: with the prediction formula being expressed by a linear sum of functions of the explanatory variables, displaying the explanatory variables used in the prediction formula on one dimensional axis by allocating a predetermined width to a respective one of the explanatory variables; and in accordance with possible values or segments of the respective explanatory variables, setting values or segments of the explanatory variables in the widths allocated thereto, and plotting values of the functions specified by the values or the segments that have been set, at corresponding positions in another dimensional axis direction.

An impact visualization program according to the present invention is an impact visualization program that is applied to a computer and that enables visualization of impacts of explanatory variables used in a prediction formula, the program causing the computer to perform: an explanatory variable displaying process of, with the prediction formula being expressed by a linear sum of functions of the explanatory variables, displaying the explanatory variables used in the prediction formula on one dimensional axis by allocating a predetermined width to a respective one of the explanatory variables; and a function value displaying process of, in accordance with possible values or segments of the respective explanatory variables, setting values or segments of the explanatory variables in the widths allocated thereto, and plotting values of the functions specified by the values or the segments that have been set, at corresponding positions in another dimensional axis direction.

### Advantageous Effects of Invention

According to the present invention, even in the ease where the impacts of explanatory variables on a prediction result vary according to the values or segments of the explanatory variables, the impacts of the explanatory variables on the prediction result can be visualized so as to be readily understood by a user.

### BRIEF DESCRIPTION OF DRAWINGS

FIG. 1 is a block diagram showing an embodiment of the impact visualization system according to the present invention.

FIG. 2 is a diagram illustrating an example of a prediction model.

FIG. 3 is a diagram illustrating an example in which function values are plotted for each explanatory variable.

FIG. 4 is a diagram illustrating another example in which function values are plotted for each explanatory variable.

FIG. 5 is a flowchart illustrating an example of the operation of the impact visualization system.

FIG. 6 is a block diagram schematically showing the impact visualization system according to the present invention.

FIG. 7 is a diagram illustrating an example in which a prediction formula is expressed by a stem plot.

### DESCRIPTION OF EMBODIMENT

An embodiment of the present invention will he described below with reference to the drawings.

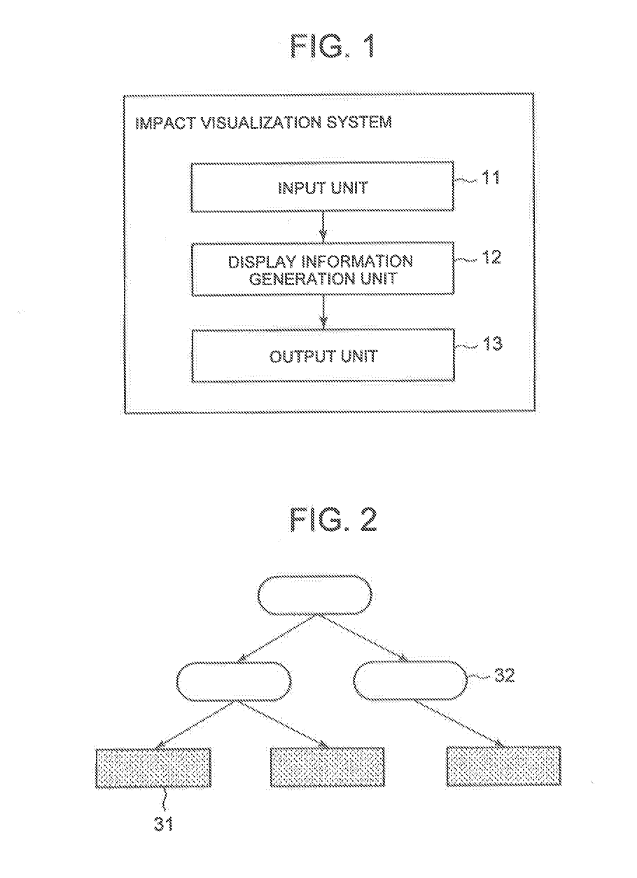

FIG. 1 is a block diagram showing an embodiment of tine impact visualization system according to the present invention. The impact visualization system of the present embodiment includes an input unit 11 a display information generation unit 12, and an output unit 13.

The input unit 11 inputs a prediction formula to be displayed, to the display information generation unit 12. For example, in the case where necessary information is stored in a storage unit (not shown), the input unit 11 may extract the information from the storage unit and input the information to the display information generation unit 12. In the case where necessary information is to be received from another system (not shown), the input unit 11 may operate as an interface for receiving the information from the other system, and input the received information to the display information generation unit 12.

The information obtained by the input unit 11 is not limited to the form of the prediction formula, 2 illustrates an example of a prediction model. When the prediction model illustrated in FIG. 2 is used, a prediction formula for use in prediction from input data is selected in accordance with the content of the input data, and the selected prediction formula is used to make a. prediction from the input data. The prediction model illustrated in FIG. 2 can be generated by, for example, the heterogeneous mixture learning described in NPL 1.

For example, in the case where a prediction model as illustrated in FIG. 2 has been input, the input unit 11 may extract from the prediction model each prediction formula for use in prediction, and input the extracted prediction formula to the display information generation unit 12. It should be noted that the method of generating the prediction model as a target of extraction is not limited to the heterogeneous mixture learning described in NPL 1.

The display information generation unit 12 generates display information for enabling visualization of impacts of explanatory variables used in a prediction formula. It is assumed in the present embodiment that a prediction formula is expressed by a linear sum of functions of the explanatory variables. Here, it is assumed that a function of an explanatory variable is expressed by a piecewise combination of linear functions, with the value of the function being uniquely determined in accordance with the value or segment of the explanatory variable. The piecewise combination of linear functions is a combination of the linear functions, defined in accordance with the value ranges or segments of the explanatory variable, and it is defined to cover possible values or segments of the explanatory variable.

In the case where the explanatory variable is a variable expressed by continuous values (for example, price, temperature, etc.), the function of the explanatory variable is, for example, a function in which a conversion method is defined for each predetermined range. In the case where the explanatory variable is a variable expressed by discrete values (segments) (for example, weather, day of the week, etc.), the function of the explanatory variable is, for example, a function in which a value is defined according to each discrete value.

The display information generation unit 12 generates display information in which the explanatory variables used in a prediction formula are arranged on one dimensional axis, with a predetermined width allocated to a respective one of the explanatory variables. In the description of the present embodiment, it is assumed that the display information is displayed on a two-dimensional space and that the axis (one dimensional axis) on which the explanatory variables are arranged is the y axis.

On the one dimensional axis, any width may be allocated to an explanatory variable. The display information generation unit 12 may allocate, to each explanatory variable, an interval width predetermined for that explanatory variable, or it may allocate equal interval widths to all explanatory variables. Further, the display information generation unit 12 may allocate, to each explanatory variable, a width according to the range of possible values (segments) of that explanatory variable.

Next, the display information generation unit 12 sets values or segments of an explanatory variable in the width allocated thereto, in accordance with possible values or segments of the explanatory variable. The values or the segments of an explanatory variable may be set in any predetermined manner. In the case where the explanatory variable is a variable expressed by continuous values, the display information generation unit 12 may set the values of the explanatory variable such that, for example, the value increases in a fixed direction of the axis. In the case where the explanatory variable is a variable expressed by discrete values (segments), the display information generation unit 12 may set the segments of the explanatory variable such that, for example, each segment is set in a width obtained by dividing the allocated width by the number of possible segments.

Next, the display information generation unit 12 generates display information in which values of the functions specified by the values or the segments that have been set are plotted at corresponding positions in another dimensional axis direction. In the present embodiment, it is assumed that the function. values are displayed in the x axis (the other dimensional axis) direction.

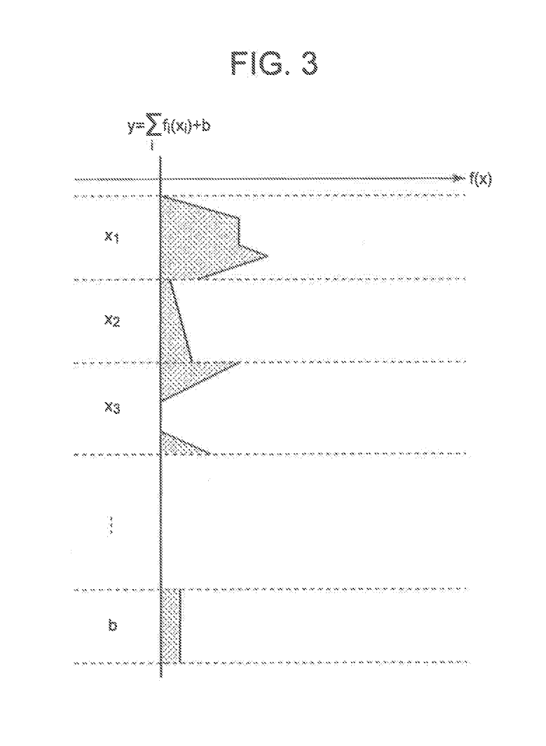

FIG. 3 is a diagram illustrating, an example in which function values are plotted for each explanatory variable, in the example shown in FIG. 3, explanatory variables taking continuous values are arranged in the vertical axis direction (y axis direction), and the function values are plotted in the horizontal axis direction (x axis direction).

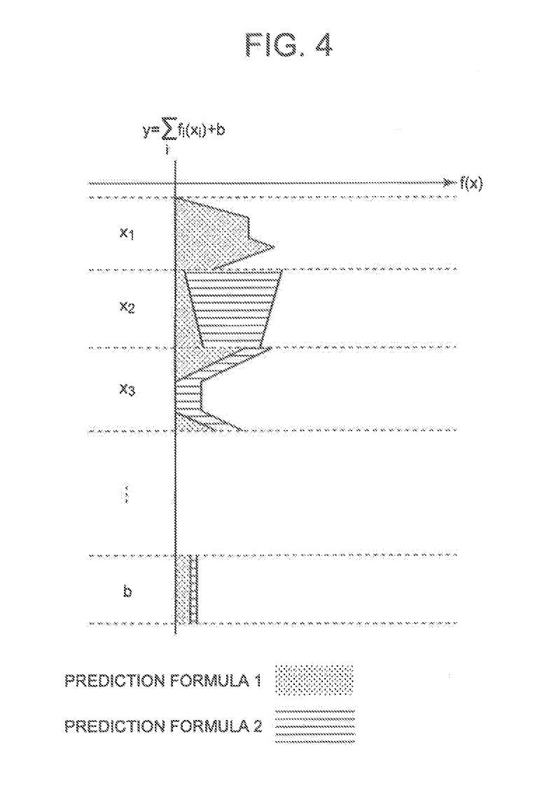

In the case where there are two or more prediction formulas, the display information generation unit 12 may plot function values at corresponding positions where the values of the functions specified by the explanatory variables in the respective prediction formulas are accumulated. FIG. 4 is a diagram illustrating another example in which function values are plotted for each explanatory variable.

In the example shown in FIG. 4, explanatory variables used in at least one of two prediction formulas (prediction formula 1, prediction formula 2) are arranged on the y axis, and values of the functions of the explanatory variables used in the prediction formula 2 are accumulated on values of the functions of the explanatory variables used in the prediction formula 1. it is noted that the example shown in FIG. 4 indicates that the explanatory variable xᵢ is not used in the prediction formula 2 and, thus, no function value is accumulated for that variable.

Displaying the function values cumulatively in the above-described manner facilitates understanding, at a glance, the impacts of the explanatory variables over a plurality of prediction formulas. It is noted that the function values may be accumulated in any order. For example, the display information generation unit 12 may accumulate the function values in the order of identifiers that identify the respective prediction formulas.

For example, in the case where a prediction formula for use in prediction from input data. is selected in accordance with the content of the input data and the selected prediction formula is used to make a prediction from the input data, as in the prediction model generated by the heterogeneous mixture learning described in NPL 1, there exist two or more prediction formulas selected.

In the case where these prediction formulas are each expressed by a linear sum functions of explanatory variables, it is difficult, with a normal stem plot, to make it understand the impacts of the explanatory variables in the plurality of prediction formulas because the term of each explanatory variable is expressed by a function, in contrast, in the present embodiment, a graph is displayed in which values of the functions of the respective explanatory variables are accumulated. Such a display enables understanding, at a glance, the explanatory variables used in the prediction formulas and also the impacts of the explanatory variables on a predicted value. This leads to an improved interpretation of the prediction model. Thus, for example when there occurs a problem or degradation in performance in such a prediction model as described above, it also becomes readily possible to find out the cause of the problem.

The output unit 13 outputs the display information generated by the display information generation unit 12. For example, in the case where the output unit 13 is implemented by a display device, the output unit 13 by itself may display the display information. Alternatively, the output unit 13 may send an output instruction of the display information to another display device (not shown) to cause the display information to be output.

Further, in the present embodiment, a description has been made about the case where display information is generated by the display information generation unit 12 and, then, the display information is output by the output unit 13. Alternatively, it may be configured such that display information is displayed on a display device (not shown) each time the display^{,} information generation unit 12 generates the display information.

The input unit 11 and the display information generation unit 12 are each implemented by a CPU of a computer that operates in accordance with a program (impact visualization program). For example, the program may be stored in a storage unit (not shown) included in the impact visualization system, and the CPU may read the program and operate as the input unit 11 and the display information generation unit 12 in accordance with the program.

In the impact visualization system of the present embodiment, the input unit 11, the display information generation unit 12, and the output unit 13 may each be implemented by dedicated hardware. Further, the impact visualization system according to the present invention may be configured with two or more physically separate devices which are connected in a wired or wireless manner.

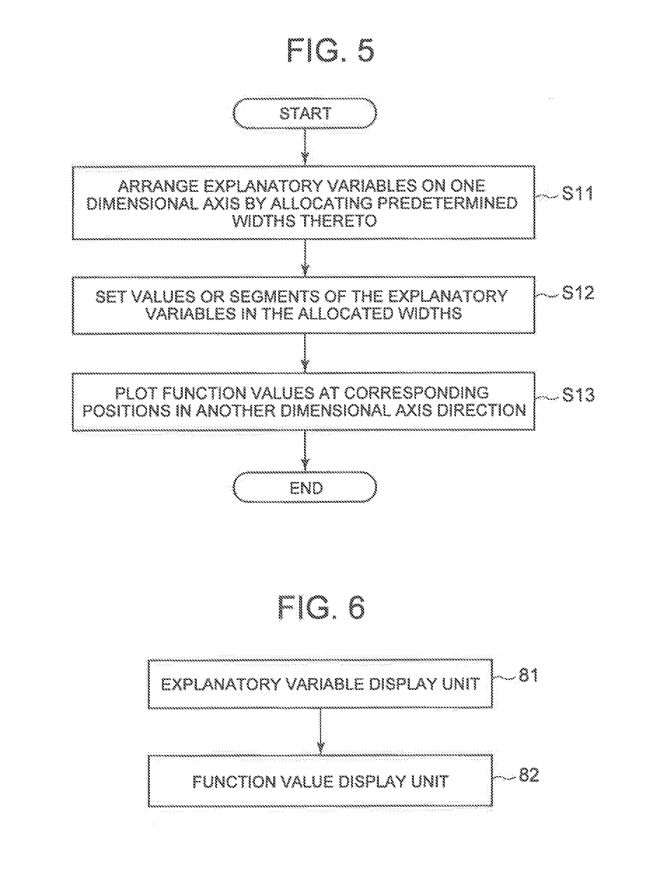

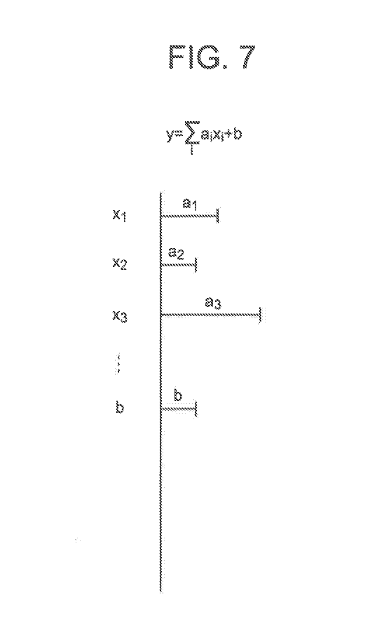

An operation of the impact visualization system of the present embodiment will now be described. FIG. 5 is a flowchart illustrating an example of the operation of the impact visualization system of the present embodiment. In this operation example, it is assumed that the display information generation unit 12 sequentially displays generated display information.

The display information generation unit 12 displays explanatory variables used in a prediction formula input b the input unit 11 on one dimensional axis (y axis) by allocating a predetermined width to a respective one of the explanatory variables (step S11). Next, the display information generation unit 12 sets values or segments of the explanatory variables in the widths allocated thereto, in accordance with possible values or segments of the respective explanatory variables (step S12). The display information generation unit 12 then plots values of the functions specified by the values or the segments that have been set, at corresponding positions in the other dimensional axis (x axis) direction (step S13).

As described above, in the present embodiment, a prediction formula is expressed by a linear sum of functions of explanatory variables, and the display information generation unit 12 displays the explanatory variables used in the prediction formula on one dimensional axis by allocating a predetermined width to a respective one of the explanatory variables. Further, the display information generation unit 12 sets values or segments of the explanatory variables in the widths allocated thereto, in accordance with possible values or segments of the respective explanatory variables, and plots values of the functions specified by the values or the segments that have been set, at corresponding positions in the other dimensional axis direction. With such a configuration, even in the case where the impacts of explanatory variables on a prediction result vary in accordance with the values or segments of the explanatory variables, the impacts of the explanatory variables on the prediction result can be visualized so as to be readily understood by a user.

The present invention will be outlined below FIG. 6 is a block diagram schematically showing the impact visualization system according to the present invention. The impact visualization system according to the present invention is an impact visualization system that enables visualization of impacts of explanatory variables used in a prediction formula, with the prediction formula being expressed by a linear sum of functions of the explanatory variables. The system includes: an explanatory variable display unit 81 (for example, the display information generation unit 12, the output unit 13) that displays the explanatory variables used in the prediction formula on one dimensional axis (for example, the y axis in the two-dimensional space) by allocating a predetermined width to a respective one of the explanatory variables; and a function value display unit 82 (for example, the display information generation unit 12, the output unit 13) that sets values or segments of the explanatory variables in the widths allocated thereto, in accordance with possible values or segments of the respective explanatory variables, and plots values of the functions specified by the values or the segments that have been set, at corresponding positions in another dimensional axis direction.

With such a configuration, even in the case where the impacts of explanatory variables on a prediction result vary in accordance with the values or segments of the explanatory variables, it is possible to visualize the impacts of the explanatory variables on the prediction result such that a user can readily understand the impacts.

In the case where there are two or more prediction formulas to be displayed, the function value display unit 82 may plot function values at corresponding positions where the values of the functions specified by the explanatory variables in the respective prediction if formulas are accumulated. Such a configuration allows the explanatory variables used in a plurality of prediction formulas as well as the impacts of the explanatory variables on a predicted value to be understood at a glance.

Further, the impact visualization system may include a prediction formula extraction unit (for example, the input unit 11) that extracts each prediction formula from a prediction model in which a prediction formula for use in prediction from input data is selected in accordance with the content of the input data and the selected prediction formula is used to make a prediction from the input data.

Specifically, the function of an explanatory variable is expressed by a piecewise combination of linear functions, with the value of the function being uniquely determined in accordance with the value or the segment of the explanatory variable.

While the present invention has been described with reference to an embodiment and examples, the present invention is not limited to the embodiment or examples above, Various modifications appreciable by those skilled in the art are possible to the configuration and details of the present invention within the scope of the present invention.

This application claims priority based on U.S. Provisional Application Ser. No. 62/117,555 filed Feb. 18, 2015, the disclosure of which is incorporated herein in its entirety.

### INDUSTRIAL APPLICABILITY

The present invention is suitably applied to an impact visualization system that enables visualization of the impacts of explanatory variables used in prediction formulas. For example, it is suitably applied to an apparatus that enables visualization of the impacts of the explanatory variables used in each prediction formula in a prediction model generated by heterogeneous mixture learning.

### REFERENCE SIGNS LIST

11 input unit
12 display information generation unit
13 output unit

1. An Impact visualization system enabling visualization of impacts of explanatory variables used in a prediction formula, the system comprising:
a hardware including a processor;
an explanatory variable display unit, implemented by the processor, which, with the prediction formula being expressed by a linear sum of functions of the explanatory variables, displays the explanatory variables used in the prediction formula on one dimensional axis by allocating a predetermined width to a respective one of the explanatory variables; and
a function value display unit, implemented by the processor, which, in accordance with possible values or segments of the respective explanatory variables, sets values or segments of the explanatory variables in the widths allocated thereto, and plots values of the functions specified by the values or the segments that have been set, at corresponding positions in another dimensional axis direction.

2. The impact visualization system according to claim 1, wherein in a case where there are a plurality of said prediction formulas to be displayed, the function value display unit plots function values at corresponding positions where the values of the functions specified by the explanatory variables in the respective prediction formulas are accumulated.

3. The impact visualization system according to claim 1, comprising a prediction formula extraction unit, implemented by the processor, that extracts each prediction formula from a prediction model in which a prediction formula for use in prediction from input data is selected in accordance with content of the input data and the selected prediction formula is used to make a prediction from the input data.

4. The impact visualization system according to claim 1, wherein the function of the explanatory variable is expressed by a piecewise combination of linear functions, with the value of the function being uniquely determined in accordance with the value or the segment of the explanatory variable.

5. An impact visualization method enabling visualization of impacts of explanatory variables used in a prediction formula, comprising:
with the prediction formula being expressed by a linear sum of functions of the explanatory variables, displaying the explanatory variables used in the prediction formula on one dimensional axis by allocating a predetermined width to a respective one of the explanatory variables; and
in accordance with possible values or segments of the respective explanatory variables, setting values or segments of the explanatory variables in the widths allocated thereto, and plotting values of the functions specified by the values or the segments that have been set, at corresponding positions in another dimensioned axis direction.

6. The impact visualization method according to claim 5, comprising, in a case where there are a plurality of said prediction formulas to be displayed, plotting function values at corresponding positions where the values of the functions specified by the explanatory variables in the respective prediction formulas are accumulated,

7. A non-transitory computer readable information recording medium storing an impact visualization program applied to a computer, the program enabling visualization of impacts of explanatory variables used in a prediction formula, when executed by a processor, the program performs a method for:
with the prediction formula being expressed by a linear sum of functions of the explanatory variables, displaying the explanatory variables used in the prediction formula on one dimensional axis by allocating a predetermined width to a respective one of the explanatory variables; and
in accordance with possible values or segments of the respective explanatory variables., setting values or segments of the explanatory variables in the widths allocated thereto, and plotting values of the functions specified by the values or the segments that have been set, at corresponding positions in another dimensional axis direction.

8. The non-transitory computer readable information recording medium according to claim 7, in a case where there are a plurality of said prediction formulas to be displayed, plotting function values at corresponding positions where the values of the functions specified by the explanatory variables in the respective prediction formulas are accumulated.
